(19) United States
(12) Patent Application Publication
(10) Pub. No.: US 2023/0331034 A1
(43) Pub. Date: Oct. 19, 2023

(54) WHEEL OF A COLLAPSIBLE BICYCLE

(71) Applicant: TUNG KENG ENTERPRISE CO., LTD., TAICHUNG (TW)

(72) Inventor: CHIU-HSIANG LO, TAICHUNG (TW)

(21) Appl. No.: 17/722,390

(22) Filed: Apr. 18, 2022

(51) Int. Cl. B60B 1/00; B60B 1/06

(52) U.S. Cl. CPC B60B 1/003; B60B 1/06

(57) ABSTRACT

A wheel is devised for a collapsible bicycle. The wheel includes a rim, a hub, and spokes. The rim, the hub and the spokes are made in one piece. The rim includes a ring extending along a center line and a clincher extending from an external face of the ring. The hub includes a first end, a second end, and a depth measured from the first end to the second end. The spokes extend to the center line of the ring from the first end of the hub so that a middle point of the depth lies in a plane defined by the center line.

### BACKGROUND OF INVENTION

### 1. Field of Invention

The present invention relates to a collapsible bicycle and, more particularly, to a compact wheel for a collapsible bicycle.

### 2. Related Prior Art

Referring to FIG. 6, a front wheel includes a hub 81, a rim 82, spokes 83, and nipples 85. The hub 81 includes two flanges (not numbered). Each of the flanges of the hub 81 includes orifices (not numbered). Each of the spokes 83 includes a but 84 at an end and a threaded section (not shown) at another end. Each of the spokes 83 includes a section inserted in one of the orifices of one of the flanges of the hub 81. The rim 82 includes apertures (not numbered). Each of the nipples 85 includes a section inserted in one of the apertures of the rim 82. Each of the nipples 85 includes a screw hole (not shown) for receiving the threaded section of one of the spokes 83. Thus, an enlarged head of each of the nipples 85 is abutted against the rim 82 and the buts 84 are abutted against the flanges of the hub 81. The rim 82 includes a clincher 86. A tire 87 is attached to the clincher 86.

The hub 81 is connected to a fork 80 of a bicycle. For example, the fork 80 includes two prongs for holding two terminal sections of the hub 81. To this end, the length of the hub 81 must be longer than a distance between lower ends of the prongs of the fork 80.

A rear wheel is structurally the front wheel. However, the rear wheel is wider than the front wheel. The rear wheel is connected to a chain stay (not shown) of a bicycle. The chain stay includes two prongs for holding the terminal sections of the hub of the rear wheel. To this end, the length of the hub of the rear wheel must be longer than a distance between lower ends of the prongs of the chain stay.

Where the front and rear wheels are used in a collapsible bicycle, the front and rear wheels are located side by side when the bicycle is collapsed. A sum of the lengths of the hubs of the front and rear wheels is too large to effectively reduce the volume of the bicycle in the collapsed position.

The present invention is therefore intended to obviate or at least alleviate the problems encountered in the prior art.

### SUMMARY OF INVENTION

It is the primary objective of the present invention to provide a wheel for a collapsible bicycle so that the wheel allows the bicycle to occupy a small space in a collapsed position.

To achieve the foregoing objective, the wheel includes a rim, a hub, and spokes. The rim, the hub and the spokes are made in one piece. The rim includes a ring extending along a center line and a clincher extending from an external face of the ring. The hub includes a first end, a second end, and a depth measured from the first end to the second end. The spokes extend to the center line of the ring from the first end of the hub so that a middle point of the depth lies in a plane defined by the center line.

Other objectives, advantages and features of the present invention will be apparent from the following description referring to the attached drawings.

### BRIEF DESCRIPTION OF DRAWINGS

The present invention will be described through detailed illustration of three embodiments referring to the drawings wherein:

FIG. 1 is a side view of a wheel according to the first embodiment of the present invention;

FIG. 2 is a cross-sectional view of the wheel shown in FIG. 1;

FIG. 3 is a cross-sectional view of the wheel shown in FIG. 1 and another identically configured but oppositely located;

FIG. 4 is a cross-sectional view of a wheel according to the second embodiment of the present invention;

FIG. 5 is a cross-sectional view of a wheel according to the third embodiment of the present invention;

FIG. 6 is a cross-sectional view of a conventional wheel.

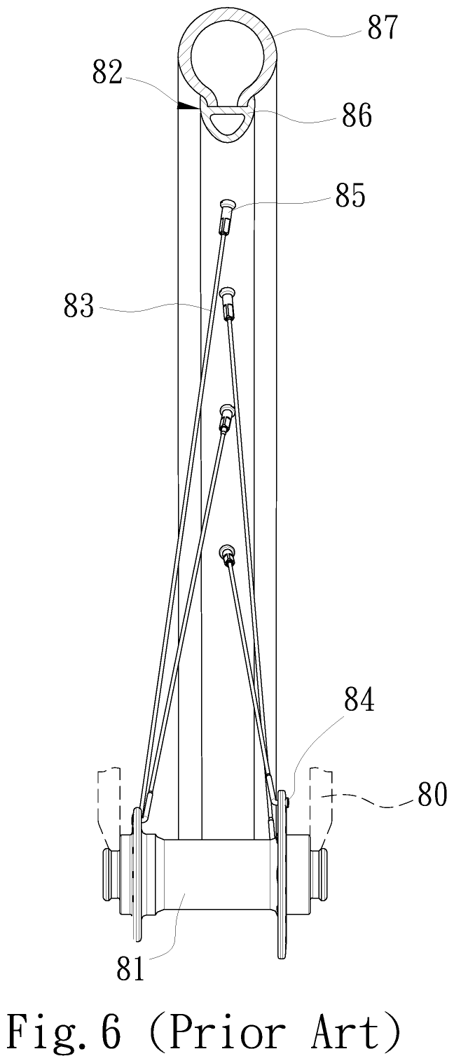

### DETAILED DESCRIPTION OF EMBODIMENTS

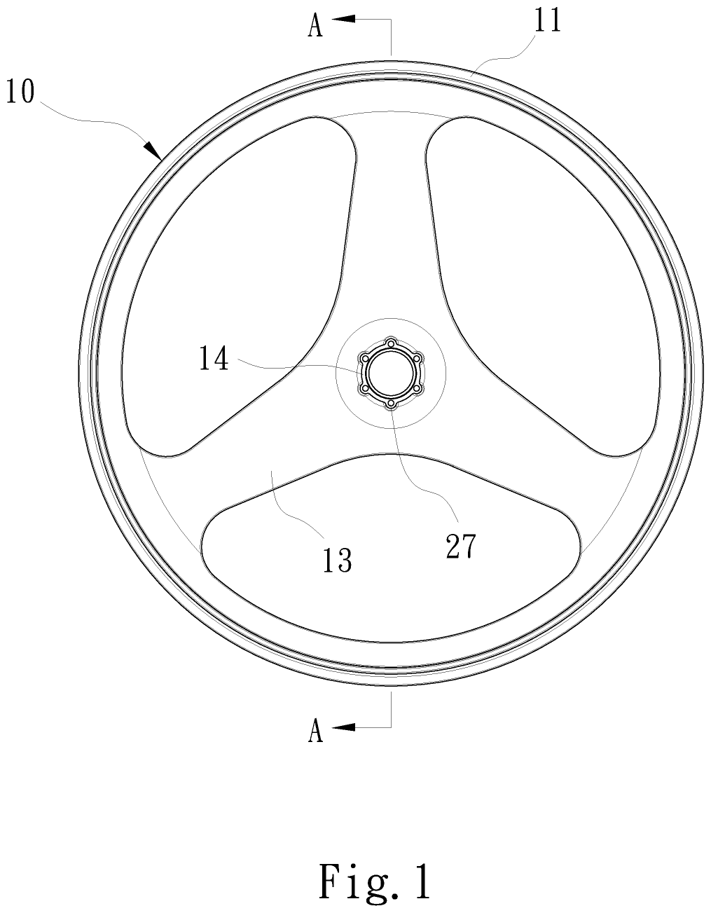

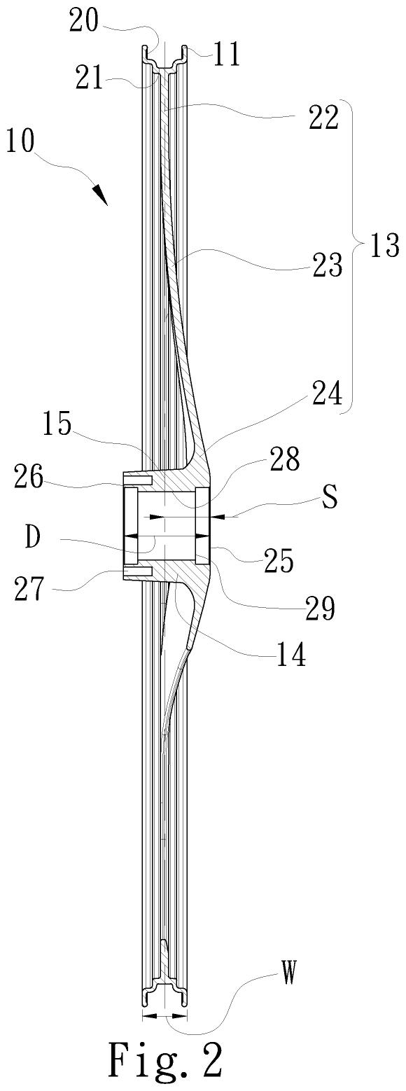

Referring to FIGS. 1 and 2, an integral wheel 10 for a collapsible bicycle includes a rim 11, spokes 13 and a hub 14 according to a first embodiment of the present invention. The term “integral” suggests that the rim 11, the spokes 13 and the hub 14 are made in one piece by molding or any other proper means.

The rim 11 includes a clincher 20 extending from an external side of a ring 21, i.e., away from the hub 14. In specific, the clincher 20 includes two jaws (not numbered) extending from an external side of the ring 21. The distance between external faces of the jaws of the clincher 20 is referred to as the “width W” of the rim 11. A center line 15 extends in and along the ring 21 of the rim 11.

The hub 14 includes a channel 28 and two cavities 29. The channel 28 extends from an end or side 25 to another end or side 26. One of the cavities 29 is in communication with the channel 28 at the end 25. The other one of the cavities 29 is in communication with the channel 28 at the end 26. Preferably, the diameter of the cavities 29 is larger than the diameter of the channel 28. The distance between the ends 25 and 26 is referred to as the “depth D” of the channel 28 of the hub 14.

The wheel includes a supportive portion (not numbered) extending around the end 25 of the hub 14. The supportive portion is formed between the hub 14 and each of the spokes 13. In a radial manner, the spokes 13 extend to the center line 15 of the ring 21 of the rim 11 from the supportive portion, which extends from the end 25 of the hub 14.

The ends 25 and 26 of the hub 14 are both biased from the center line 15. Hence, each of the spokes 13 extends in a curved manner. In detail, each of the spokes 13 includes a rectilinear section 22 and a curved section 23. The rectilinear section 22 extends from the ring 21 of the rim 11. Preferably, the rectilinear section 22 extends in a plane defined by the center line 15 of the ring 21. The curved section 23 extends from the rectilinear section 22 to the end 25 of the hub 14. In detail, each of the spokes 13 further includes a root 24 formed between the curved section 23 and the hub 14. The thickness of the root 24 is larger than the thickness of the curved section 23. The hub 14 includes screw holes 27 arranged evenly around the end 26.

In another embodiment, the supportive portion extends from the end 26 of the hub 14, and the spokes 13 extend to the center line 15 of the ring 21 of the rim 11 from the supportive portion, which extends from the end 26 of the hub 14. The screw holes 27 are arranged evenly around the end 25.

The depth D of the hub 14 extends perpendicular to the plane defined by the center line 15 of the ring 21. A middle or center point of the thickness D of the hub 14 lies in the plane defined by the center line 15 of the ring 21 although the curved section 23 of each of the spokes 13 extends from the end 25 or 26 of the hub 14, which is biased from the plane defined by the center line 15 of the ring 21. Thus, the wheel 10 is allowed to roll smoothly on the road. The distance S of the first end 25 from the center line 15 is identical to the distance S of the end 26 from the center line 15. Hence, the distance S is half the depth D of the hub 14. Preferably, the distance S is equal to the width W of the rim 11. However, in another embodiment, the distance S can be smaller or larger than the width W of the rim 11.

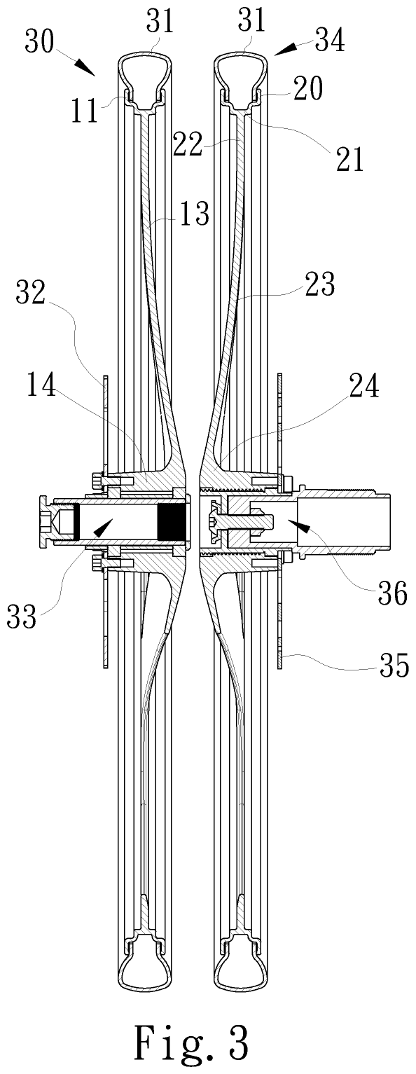

Referring to FIGS. 2 and 3, a tire 31 is attached to the clincher 20 of the rim 11 of the wheel 10. In specific, two edges of the tire 31 are clamped by the jaws of the clincher 20 of the rim 11 of the wheel 10.

Referring to FIG. 3, there are shown a front wheel set 30 and a rear wheel set 34. Each of the front and rear wheel sets 30 and 34 includes the tire 31 connected to the clincher 20 of the rim 11 of the wheel 10 shown in FIGS. 1 and 2.

A front brake disc 32 is attached to the hub 14 of the wheel 10 of the front wheel set 30 by inserting screws (not numbered) in the screw holes 27 made in the hub 14 of the wheel 10 of the front wheel set 30. A rear brake disc 35 is attached to the hub 14 of the wheel 10 of the rear wheel set 34 by inserting screws (not numbered) in the screw holes 27 made in the hub 14 of the wheel 10 of the rear wheel set 34.

In use, a section of a front axle 33 is inserted in the hub 14. The front axle 33 is connected to a fork of a collapsible bicycle (not shown). A section of a rear axle 36 is inserted in the hub 14 of the wheel 10 of the rear wheel set 34. The rear axle 36 is connected to a chain stay of the collapsible bicycle (not shown).

The curved sections 23 of the spokes 13 of the wheels 10 of the front and rear wheel sets 30 and 34 are located between the front and rear brake discs 32 and 35 when the collapsible bicycle is collapsed. The curved sections 23 of the spokes 13 of the wheels 10 of the front and rear wheel sets 30 and 34 that extend from the ends 25 (or 26) of the hubs 14 of the wheels 10 of the front and rear wheel sets 30 and 34 are located very close to each other.

The middle point of the depth D of the hub 14 lies in the plane defined by the center line 15 (FIG. 2) of the rim 11 while the end 25 or 26 of the hub 14 is biased from the plane defined by the center line 15 of the rim 11. Thus, the depth D of the hub 14 can be minimized, and so is the width of the collapsible bicycle in the collapsed position.

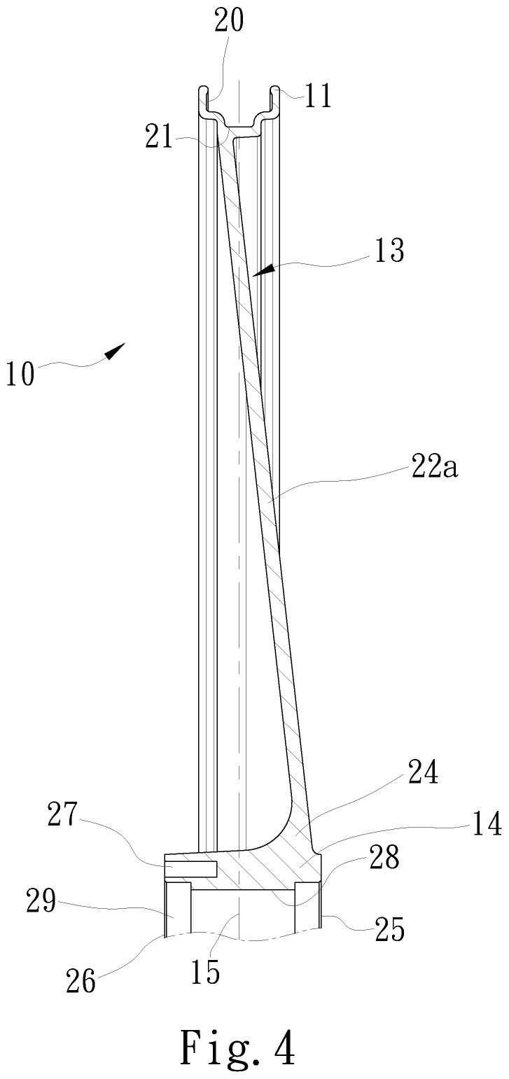

Referring to FIG. 4, there is a wheel 10 according to a second embodiment of the present invention. The second embodiment is like the first embodiment except for that each of the spokes 13 includes a rectilinear section 22a only. An end of the rectilinear section 22a is connected to the ring 21 of the rim 11, and another end of the rectilinear section 22a is connected to the end 25 or 26 of the hub 14.

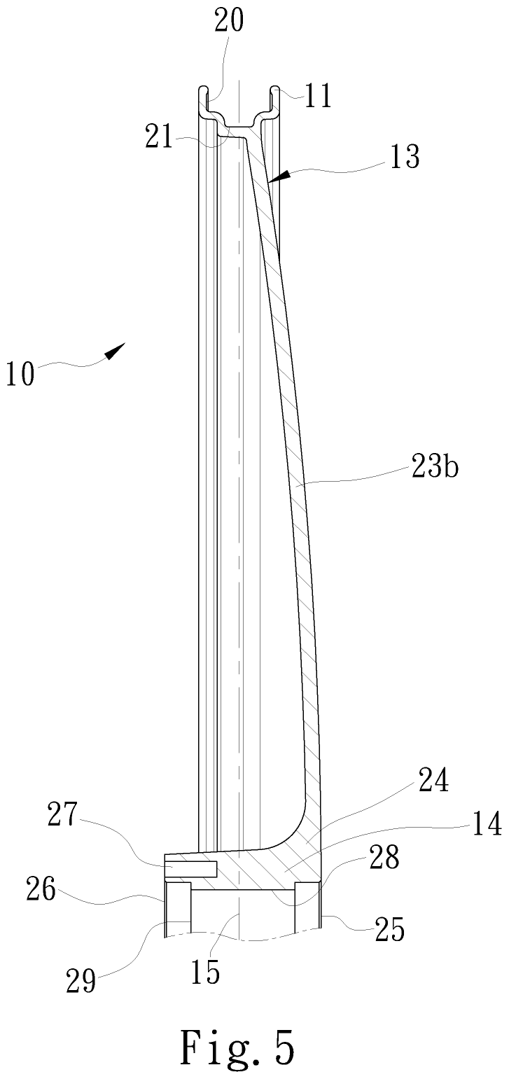

Referring to FIG. 5, there is a wheel 10 according to a third embodiment of the present invention. The third embodiment is like the first embodiment except for that each of the spokes 13 includes a curved section 23b only. An end of the curved section 23b is connected to the ring 21 of the rim 11, and another end of the curved section 23b is connected to the end 25 or 26 of the hub 14.

The present invention has been described through the illustration of the embodiments. Those skilled in the art can derive variations from the embodiments without departing from the scope of the present invention. Hence, the embodiments shall not limit the scope of the present invention defined in the claims.

1. A wheel for a collapsible bicycle comprising:
a rim comprising a ring extending along a center line and a clincher extending from an external face of the ring;
a hub comprising a first end, a second end, and a depth measured from the first end to the second end; and
spokes extending to the center line of the ring from the first end of the hub so that a middle point of the depth lies in a plane defined by the center line, wherein the rim, the hub and the spokes are made in one piece.

2. The wheel according to claim 1, wherein each of the spokes comprises a rectilinear section extending from the center line of the ring and a curved section extending from the first end of the hub.

3. The wheel according to claim 2, wherein the rectilinear section of each of the spokes lies in the plane defined by the center line.

4. The wheel according to claim 2, wherein the curved section comprises a thickness-increased root connected to the hub.

5. The wheel according to claim 1, wherein each of the spokes comprises a rectilinear section formed with an end connected to the ring and another end connected to the hub.

6. The wheel according to claim 1, wherein each of the spokes comprises a curved section formed with an end connected to the ring and another end connected to the hub.

7. The wheel according to claim 1, wherein the hub comprises screw holes evenly arranged in the second end of the hub.
